(19) United States
(12) Patent Application Publication
(10) Pub. No.: US 2016/0100165 A1
(43) Pub. Date: Apr. 7, 2016

(54) Adapting Encoding Properties

(71) Applicant: Microsoft Technology Licensing, LLC, Redmond, WA (US)

(72) Inventor: David Yuheng Zhao, Enebyberg (SE)

(21) Appl. No.: 14/559,617

(22) Filed: Dec. 3, 2014

(30) Foreign Application Priority Data
Oct. 3, 2014 (GB) 1417535.0

(51) Int. Cl. H04N 19/124; H04N 19/146; H04N 19/51

(52) U.S. Cl. CPC H04N 19/124; H04N 19/51; H04N 19/146

(57) ABSTRACT

A device, computer program and method for encoding a video signal representing a video image of a scene captured by a camera. The device comprises a controller for receiving skeletal tracking information from a skeletal tracking algorithm relating to one or more skeletal features of a user when present in the scene, wherein the controller is configured to adapt a current value of one or more motion-related properties of the encoding in dependence on the skeletal tracking information as currently relating to the scene.

### RELATED APPLICATIONS

This application claims priority under 35 USC §119 or §365 to Great Britain Patent Application No. 1417535.0, filed Oct. 3, 2014, the disclosure of which is incorporate in its entirety.

### BACKGROUND

In video coding, quantization is the process of converting samples of the video signal (typically the transformed residual samples) from a representation on a higher granularity scale to a representation on a lower granularity scale. For example, if the transformed residual YUV or RGB samples in the input signal are each represented by values on a scale from 0 to 255 (8 bits), the quantizer may convert these to being represented by values on a scale from 0 to 15 (4 bits). The minimum and maximum possible values 0 and 15 on the output scale still represent the same (or approximately the same) minimum and maximum sample amplitudes as the minimum and maximum possible values on the input scale, but now there are fewer levels of gradation in between. That is, the step size is reduced. Hence some detail is lost from each frame of the video, but the signal is smaller in that it incurs fewer bits per frame. Quantization is sometimes expressed in terms of a quantization parameter (QP), with a lower QP representing a finer granularity and a higher QP representing a coarser granularity.

Note: quantization specifically refers to the process of converting the value representing each given sample from a representation on a finer granularity scale to a representation on a coarser granularity scale. Typically this means quantizing one or more of the colour channels of each coefficient of the residual signal in the transform domain, e.g. each RGB (red, green blue) coefficient or more usually YUV (luminance and two chrominance channels respectively). For instance a Y value input on a scale from 0 to 255 may be quantized to a scale from 0 to 15, and similarly for U and V, or RGB in an alternative colour space (though generally the quantization applied to each colour channel does not have to be the same). The number of samples per unit area is referred to as resolution, and is a separate concept. The term quantization is not used to refer to a change in resolution, but rather a change in granularity per sample.

Video encoding is used in a number of applications where the size of the encoded signal is a consideration, for instance when transmitting a real-time video stream such as a stream of a live video call over a packet-based network such as the Internet. Using a finer granularity quantization results in less distortion in each frame (less information is thrown away) but incurs a higher bitrate in the encoded signal. Conversely, using a coarser granularity quantization incurs a lower bitrate but introduces more distortion per frame. Another factor which affects the bitrate is the frame rate, i.e. the number of frames in the encoded signal per unit time. A higher frame rate preserves more temporal detail (e.g. appearing more fluid) but incurs a higher bitrate, while a lower frame rate incurs fewer bits but at the expense of temporal detail (e.g. resulting in motion blur or a perceived “jerkiness” in the video).

Some codecs attempt to adapt factors such as the quantization and frame rate in dependence on the video being encoded. These work by analysing the motion estimation that is already being performed by the encoder for the purpose of compression. According to motion estimation (also called inter-frame prediction) each frame is divided into a plurality of blocks, and each block to be encoded (the target block) is encoded relative to a block-sized reference portion of a preceding frame offset relative to the target block by a motion vector. The signal is then encoded in terms of the respective motion vector of each target block, and the difference (the residual) between the target block and the respective reference portion. The reference portion is typically selected based on its similarity to the target block, so as to create as small a residual as possible. The technique exploits temporal correlation between frames in order to encode the signal using fewer bits than if encoded in terms of absolute sample values.

### SUMMARY

By determining how much motion there is in the video, an encoder may adapt factors such as the quantization parameter or frame rate based on this. For instance, the viewer notices the coarseness of the quantization more in static images than in moving images, so the encoder may adapt its quantization accordingly. Further, a higher frame rate is more appropriate to videos with more motion, so again the encoder may adapt accordingly. In situations such as real-time transmission over a network, there may only be a limited bandwidth available and it may be necessary to balance the bitrate incurred by factors such as the quantization parameter and the frame rate. For video containing a lot of fast motion, the frame rate tends to have more of an impact on the viewer's perception and therefore a higher frame rate is more of a priority than a fine quantization (low QP); whereas for video containing little motion, the quantization has more of an impact on the viewer's perception and so a fine quantization (low QP) is more of a priority than a high frame rate.

However, the above technique of analysing the encoder's motion estimation (inter-frame prediction) only gives a measure of how much motion there is in the frame generally, based on a bland, statistical view of the signal without any understanding of its content—i.e. it is not aware of what the video actually means, in terms what is moving, or which parts of the video image may be more relevant than others. It would be desirable to find an alternative technique that is able to take into account the content of the video when assessing motion.

Recently skeletal tracking systems have become available, which use a skeletal tracking algorithm and one or more sensors such as an infrared depth sensor to track one or more skeletal features of a user. Typically these are used for gesture control, e.g. to control a computer game. However, it is recognised herein that such a system could have an application to adapting motion-related properties of video encoding such as the quantization and/or frame rate, i.e. properties which affect the viewer's perception of quality differently depending on motion in the video.

According to one aspect disclosed herein, there is provided a device comprising an encoder for encoding a video signal representing a video image of a scene captured by a camera, e.g. an outgoing video stream of a live video call, or other such video signal to be transmitted over a network such as the Internet. The device further comprises a controller for receiving skeletal tracking information from a skeletal tracking algorithm, the skeletal tracking information relating to one or more skeletal features of a user when present in said scene. The controller is configured to adapt a current value of one or more motion-related properties of the encoding, e.g. the current quantization granularity and/or current frame rate, in dependence on the skeletal tracking information as currently relating to said scene.

In embodiments, the controller is configured to perform said adaptation of the one or more properties (e.g. to balance a trade-off between quantization granularity and frame rate) such that a bitrate of the encoding remains constant at a current bitrate budget, or at least within the current bitrate budget. E.g. the bitrate budget may be limited by a current available bandwidth over the network.

The adaptation may be based on whether or not a user is currently detected to be present in said scene based on the skeletal tracking information, and/or in dependence on motion of the user relative to said scene as currently detected based on the skeletal tracking information. In the case of dependence on motion, the adaptation may be dependent on whether or not a user is currently detected to be moving relative to said scene based on the skeletal tracking information, and/or in dependence on a degree of motion of the user currently detected based on the skeletal tracking information.

The skeletal tracking algorithm may perform the skeletal tracking based on one or more separate sensors other than said camera, e.g. a depth sensor such as an infrared depth sensor. The device may be a user device such as a games console, smartphone, tablet, laptop or desktop computer. The sensors and/or algorithm may be implemented in separate peripheral, or in said device.

For example, the adaptation may comprise: (i) applying a first granularity quantization and first frame rate when no user is currently detected to be present in the scene based on the skeletal tracking information, (ii) applying a second granularity quantization and second frame rate when a user is detected based on the skeletal tracking information to be present in the scene but not moving (wherein the second granularity is coarser than the first and the second frame rate is higher than the first), and/or (iii) applying a third granularity quantization and third frame rate when a user is detected based on the skeletal tracking information to be both present in the scene and moving (wherein the third granularity is coarser than the second and the third frame rate is higher than the second).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

To assist understanding of the present disclosure and to show how embodiments may be put into effect, reference will be made by way of example to the accompanying drawings in which:

FIG. 1 is a schematic block diagram of a communication system,

FIG. 2 is a schematic block diagram of an encoder,

FIG. 3 is a schematic block diagram of a decoder,

FIG. 4 is a schematic illustration of different quantization parameter values,

FIG. 5 is a schematic illustration of different frame rates,

FIG. 6 is a schematic block diagram of a user device,

FIG. 7 is a schematic illustration of a user interacting with a user device,

FIG. 8a is a schematic illustration of a radiation pattern,

FIG. 8b is a schematic front view of a user being irradiated by a radiation pattern, and

FIG. 9 is a schematic illustration of detected skeletal points of a user.

### DETAILED DESCRIPTION OF EMBODIMENTS

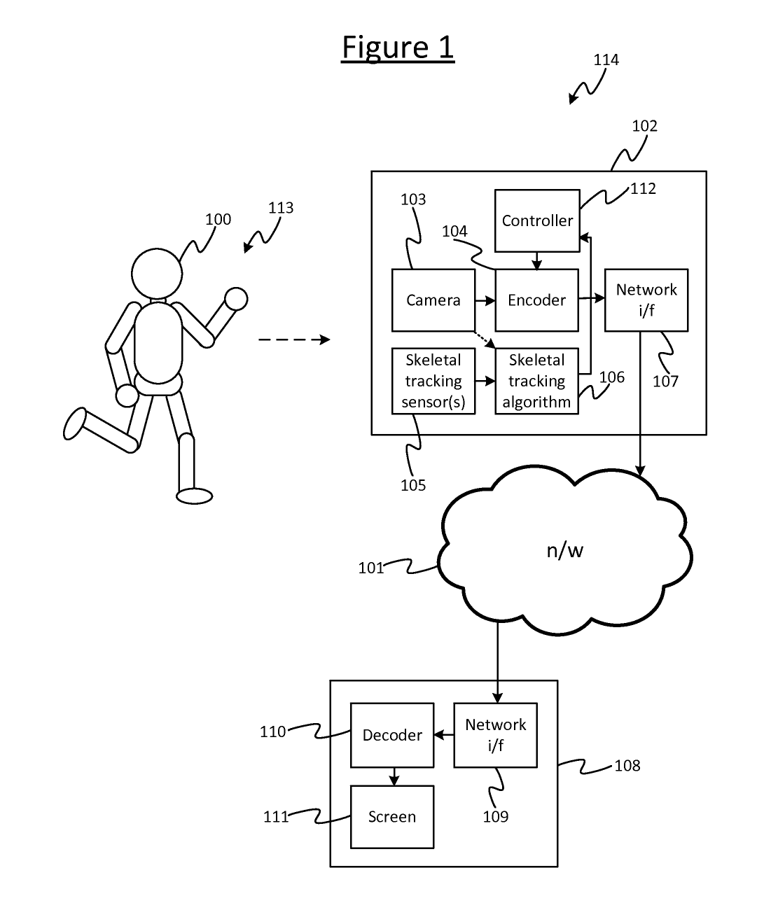

FIG. 1 illustrates a communication system 114 comprising a network 101, a first device in the form of a first user terminal 102, and a second device in the form of a second user terminal 108. In embodiments, the first and second user terminals 102, 108 may each take the form of a smartphone, a tablet, a laptop or desktop computer, or a games console or set-top box connected to a television screen. The network 101 may for example comprise a wide-area internetwork such as the Internet, and/or a wide-area intranet within an organization such as a company or university, and/or any other type of network such as a mobile cellular network. The network 101 may comprise a packet-based network, such as an internet protocol (IP) network.

The first user terminal 102 is arranged to capture a live video image of a scene 113, to encode the video in real-time, and to transmit the encoded video in real-time to the second user terminal 108 via a connection established over the network 101. The scene 113 comprises, at least at times, a (human) user 100 present in the scene 113 (meaning in embodiments that at least part of the user 100 appears in the scene 113). For instance, the scene 113 may comprise a “talking head” shot to be encoded and transmitted to the second user terminal 108 as part of a live video call, or video conference in the case of multiple destination user terminals. By “real-time” here it is meant that the encoding and transmission happen while the events being captured are still ongoing, such that an earlier part of the video is being transmitted while a later part is still being encoded, and while a yet-later part to be encoded and transmitted is still ongoing in the scene 113, in a continuous stream. Note therefore that “real-time” does not preclude a small delay.

The first (transmitting) user terminal 102 comprises a camera 103, an encoder 104 operatively coupled to the camera 103, and a network interface 107 for connecting to the network 101, the network interface 107 comprising at least a transmitter operatively coupled to the encoder 104. The encoder 104 is arranged to receive an input video signal from the camera 103, comprising samples representing the video image of the scene 113 as captured by the camera 103. The encoder 104 is configured to encode this signal in order to compress it for transmission, as will be discussed in more detail shortly. The transmitter 107 is arranged to receive the encoded video from the encoder 104, and to transmit it to the second terminal 102 via a channel established over the network 101. In embodiments this transmission comprises a real-time streaming of the encoded video, e.g. as the outgoing part of a live video call.

According to embodiments of the present disclosure, the user terminal 102 also comprises a controller 112 operatively coupled to the encoder 104, and configured to thereby adapt one or more motion-related properties of the encoding being performed by the encoder. A motion-related property as referred to herein is a property whose effect on the viewer's perceived quality varies in dependence on motion in the video being encoded. In embodiments the adapted properties comprise the quantization parameter (QP) and/or frame rate (F_frame).

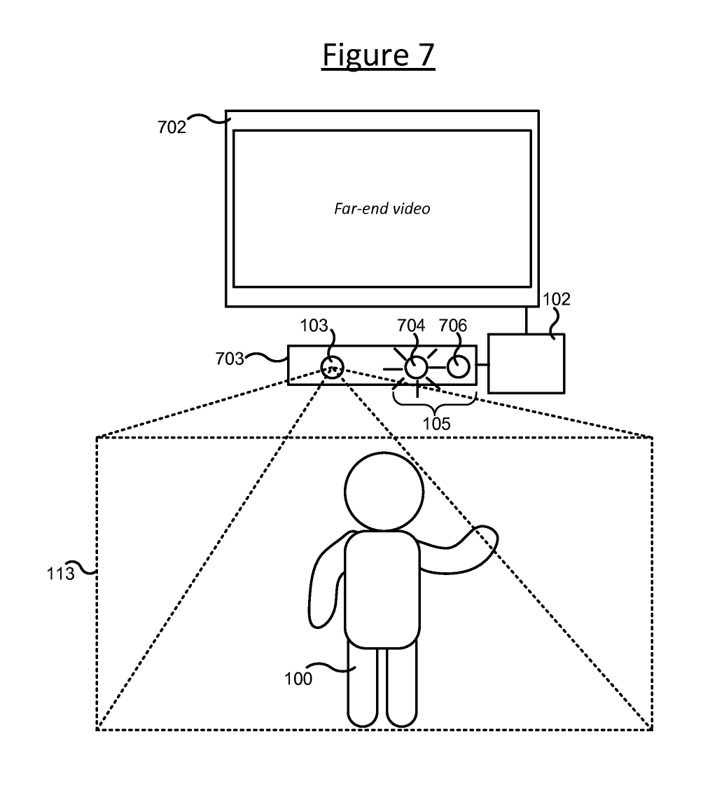

Further, the user terminal 102 comprises one or more dedicated skeletal tracking sensors 105, and a skeletal tracking algorithm 106 operatively coupled to the skeletal tracking sensor(s) 105. For example the skeletal tracking sensors(s) 105 may comprise a depth sensor such as an infrared (IR) depth sensor as discussed later in relation to FIGS. 7-9, and/or another form of dedicated skeletal tracking camera (a separate camera from the camera 103 used to capture the video being encoded), e.g. which may work based on capturing visible light or non-visible light such as IR, and which may be a 2D camera or a 3D camera such as a stereo camera or a full depth-aware (ranging) camera.

Each of the encoder 104, controller 112 and skeletal tracking algorithm 106 may be implemented in the form of software code embodied on one or more storage media of the user terminal 102 (e.g. a magnetic medium such as a hard disk or an electronic medium such as an EEPROM or “flash” memory) and arranged for execution on one or more processors of the user terminal 102. Alternatively it is not excluded that one or more of these components 104, 112, 106 may be implemented in dedicated hardware, or a combination of software and dedicated hardware. Note also that while they have been described as being part of the user terminal 102, in embodiments the camera 103, skeletal tracking sensor(s) 105 and/or skeletal tracking algorithm could be implemented in one or more separate peripheral devices in communication with the user terminal 103 via a wired or wireless connection.

The skeletal tracking algorithm 106 is configured to use the sensory input received from the skeletal tracking sensors(s) 105 to generate skeletal tracking information tracking one or more skeletal features of the user 100. For example, the skeletal tracking information may track the location of one or more joints of the user 100, such as one or more of the user's shoulders, elbows, wrists, neck, hip joints, knees and/or ankles; and/or may track a line or vector of one or more bones of the human body, such as one or more of the user's forearms, upper arms, neck, thighs or shins. In some potential embodiments, the skeletal tracking algorithm 106 may optionally be configured to augment the determination of this skeletal tracking information based on image recognition applied to the same video image that is being encoded, from the same camera 103 as used to capture the image being encoded. Alternatively the skeletal tracking is based only on the input from the skeletal tracking sensor(s) 105. Either way, the skeletal tracking is at least in part based on the separate skeletal tracking sensor(s) 105.

Skeletal tracking algorithms are in themselves available in the art. For instance, the Xbox One software development kit (SDK) includes a skeletal tracking algorithm which an application developer can access to receiving skeletal tracking information, based on the sensory input from the Kinect peripheral. In embodiments the user terminal 102 is an Xbox One games console, the skeletal tracking sensors 105 are those implemented in the Kinect sensor peripheral, and the skeletal tracking algorithm is that of the Xbox One SDK. However this is only an example, and other skeletal tracking algorithms and/or sensors are possible.

The controller 112 is configured to receive the skeletal tracking information from the skeletal tracking algorithm 106 and, based on this, adapt the one or more motion-related parameters mentioned above, e.g. the QP and/or frame rate. This will be discussed in more detail shortly.

At the receive side, the second (receiving) user terminal 108 comprises a screen 111, a decoder 110 operatively coupled to the screen 111, and a network interface 109 for connecting to the network 101, the network interface 109 comprising at least a receiver being operatively coupled to the decoder 110. The encoded video signal is transmitted over the network 101 via a channel established between the transmitter 107 of the first user terminal 102 and the receiver 109 of the second user terminal 108. The receiver 109 receives the encoded signal and supplies it to the decoder 110. The decoder 110 decodes the encoded video signal, and supplies the decoded video signal to the screen 111 to be played out. In embodiments, the video is received and played out as a real-time stream, e.g. as the incoming part of a live video call.

Note: for illustrative purposes, the first terminal 102 is described as the transmitting terminal comprising transmit-side components 103, 104, 105, 106, 107, 112 and the second terminal 108 is described as the receiving terminal comprising receive-side components 109, 110, 111; but in embodiments, the second terminal 108 may also comprise transmit-side components (with or without the skeletal tracking) and may also encode and transmit video to the first terminal 102, and the first terminal 102 may also comprise receive-side components for decoding, receiving and playing out video from the second terminal 109. Note also that, for illustrative purposes, the disclosure herein has been described in terms of transmitting video to a given receiving terminal 108; but in embodiments the first terminal 102 may in fact transmit the encoded video to one or a plurality of second, receiving user terminals 108, e.g. as part of a video conference.

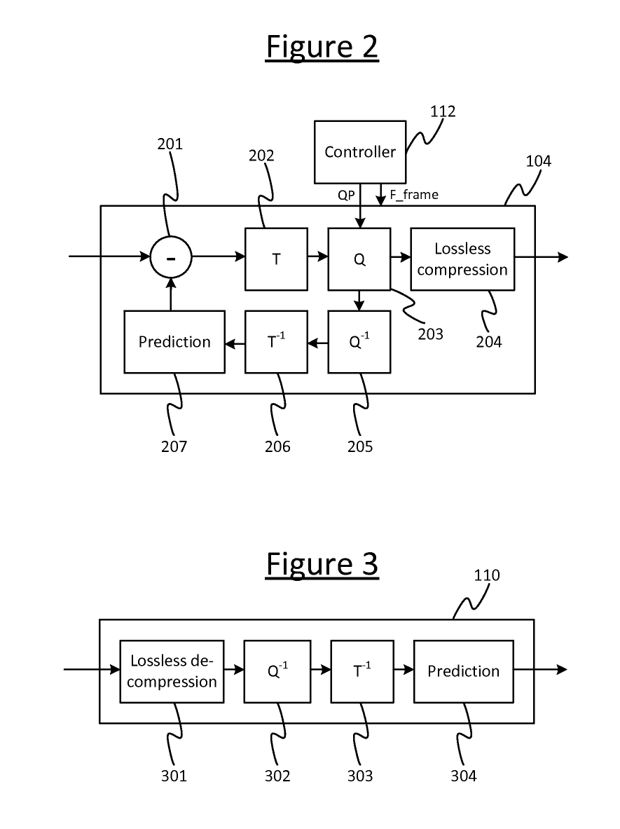

FIG. 2 illustrates an example implementation of the encoder 104. The encoder 104 comprises: a subtraction stage 201 having a first input arranged to receive the samples of the raw (unencoded) video signal from the camera 103, a prediction coding module 207 having an output coupled to a second input of the subtraction stage 201, a transform stage 202 (e.g. DCT transform) having an input operatively coupled to an output of the subtraction stage 201, a quantizer 203 having an input operatively coupled to an output of the transform stage 202, a lossless compression module 204 (e.g. entropy encoder) having an input coupled to an output of the quantizer 203, an inverse quantizer 205 having an input also operatively coupled to the output of the quantizer 203, and an inverse transform stage 206 (e.g. inverse DCT) having an input operatively coupled to an output of the inverse quantizer 205 and an output operatively coupled to an input of the prediction coding module 207.

In operation, each frame of the input signal from the camera 103 is divided into a plurality of blocks (or macroblocks or the like—“block” will be used as a generic term herein which could refer to the blocks or macroblocks of any given standard). The input of the subtraction stage 201 receives a block to be encoded from the input signal (the target block), and performs a subtraction between this and a transformed, quantized, reverse-quantized and reverse-transformed version of another block-size portion (the reference portion) either in the same frame (intra frame encoding) or a different frame (inter frame encoding) as received via the input from the prediction coding module 207 —representing how this reference portion would appear when decoded at the decode side. The reference portion is typically another, often adjacent block in the case of intra-frame encoding, while in the case of inter-frame encoding (motion prediction) the reference portion is not necessarily constrained to being offset by an integer number of blocks, and in general the motion vector (the spatial offset between the reference portion and the target block, e.g. in x and y coordinates) can be any number of pixels or even fractional integer number of pixels in each direction.

The subtraction of the reference portion from the target block produces the residual signal—i.e. the difference between the target block and the reference portion of the same frame or a different frame from which the target block is to be predicted at the decoder 110. The idea is that the target block is encoded not in absolute terms, but in terms of a difference between the target block and the pixels of another portion of the same or a different frame. The difference tends to be smaller than the absolute representation of the target block, and hence takes fewer bits to encode in the encoded signal.

The residual samples of each target block are output from the output of the subtraction stage 201 to the input of the transform stage 202 to be transformed to produce corresponding transformed residual samples. The role of the transform is to transform from a spatial domain representation, typically in terms of Cartesian x and y coordinates, to a transform domain representation, typically a spatial-frequency domain representation (sometimes just called the frequency domain). That is, in the spatial domain, each colour channel (e.g. each of RGB or each of YUV) is represented as a function of spatial coordinates such as x and y coordinates, with each sample representing the amplitude of a respective pixel at different coordinates; whereas in the frequency domain, each colour channel is represented as a function of spatial frequency having dimensions 1/distance, with each sample representing a coefficient of a respective spatial frequency term. For example the transform may be a discrete cosine transform (DCT).

The transformed residual samples are output from the output of the transform stage 202 to the input of the quantizer 203 to be quantized into quantized, transformed residual samples. As discussed previously, quantization is the process of converting from a representation on a higher granularity scale to a representation on a lower granularity scale, i.e. mapping a large set of input values to a smaller set. Quantization is a lossy form of compression, i.e. detail is being “thrown away”. However, it also reduces the number of bits needed to represent each sample.

The quantized, transformed residual samples are output from the output of the quantizer 203 to the input of the lossless compression stage 204 which is arranged to perform a further, lossless encoding on the signal, such as entropy encoding. Entropy encoding works by encoding more commonly-occurring sample values with codewords consisting of a smaller number of bits, and more rarely-occurring sample values with codewords consisting of a larger number of bits. In doing so, it is possible to encode the data with a smaller number of bits on average than if a set of fixed length codewords was used for all possible sample values. The purpose of the transform 202 is that in the transform domain (e.g. frequency domain), more samples typically tend to quantize to zero or small values than in the spatial domain. When there are more zeros or a lot of the same small numbers occurring in the quantized samples, then these can be efficiently encoded by the lossless compression stage 204.

The lossless compression stage 204 is arranged to output the encoded samples to the transmitter 107, for transmission over the network 101 to the decoder 110 on the second (receiving) terminal 108 (via the receiver 110 of the second terminal 108).

The output of the quantizer 203 is also fed back to the inverse quantizer 205 which reverse quantizes the quantized samples, and the output of the inverse quantizer 205 is supplied to the input of the inverse transform stage 206 which performs an inverse of the transform 202 (e.g. inverse DCT) to produce an inverse-quantized, inverse-transformed versions of each block. As quantization is a lossy process, each of the inverse-quantized, inverse-transformed blocks will contain some distortion relative to the corresponding original block in the input signal. This represents what the decoder 110 will see. The prediction coding module 207 can then use this to generate a residual for further target blocks in the input video signal (i.e. the prediction coding encodes in terms of the residual between the next target block and how the decoder 110 will see the corresponding reference portion from which it is predicted).

FIG. 3 illustrates an example implementation of the decoder 110. The decoder 110 comprises: a lossless decompression stage 301 having an input arranged to receive the samples of the encoded video signal from the receiver 109, an inverse quantizer 302 having an input operatively coupled to an output of the lossless decompression stage 301, an inverse transform stage 303 (e.g. inverse DCT) having an input operatively coupled to an output of the inverse quantizer 302, and a prediction module 304 having an input operatively coupled to an output of the inverse transform stage 303.

In operation, the inverse quantizer 302 reverse quantizes the received (encoded residual) samples, and supplies these de-quantized samples to the input of the inverse transform stage 303. The inverse transform stage 303 performs an inverse of the transform 202 (e.g. inverse DCT) on the de-quantized samples, to produce an inverse-quantized, inverse-transformed versions of each block, i.e. to transform each block back to the spatial domain. Note that at this stage, theses blocks are still blocks of the residual signal. These residual, spatial-domain blocks are supplied from the output of the inverse transform stage 303 to the input of the prediction module 304. The prediction module 304 uses the inverse-quantized, inverse-transformed residual blocks to predict, in the spatial domain, each target block from its residual plus the already-decoded version of its corresponding reference portion from the same frame (intra frame prediction) or from a different frame (inter frame prediction). In the case of inter-frame encoding (motion prediction), the offset between the target block and the reference portion is specified by the respective motion vector, which is also included in the encoded signal. In the case of intra-frame encoding, which block to use as the reference block is typically determined according to a predetermined pattern, but alternatively could also be signalled in the encoded signal.

As mentioned previously, the controller 112 at the encode side is configured to receive skeletal tracking information from the skeletal tracking algorithm 106, and based on this to dynamically adapt one or more motion-related properties such as the QP and/or frame rate of the encoded video. For example the skeletal tracking information may indicate, or allow the controller to determine, one or more of:
(a) whether or not a user 100 is present in the scene 113 (either detecting whether the whole user is present in the scene, or whether at least one or more of one or more specific parts of the user is/are present in the scene, or whether at least any part of the user is present in the scene);
(b) whether or not a user 100 present in the scene 113 is moving (either detecting whether the whole user is present and moving, or whether at least one or more of one or more specific parts of the user are present and moving, or whether at least any part of the user is present and moving);
(c) which part of the user 100 is moving in the scene 113; and/or
(d) a degree of motion of a user in the scene 113 (either a degree of motion of a specific skeletal feature such as its speed and/or direction, or an overall measure such as an average or net speed and/or direction of all of a given user's skeletal features present in the scene 113).

The controller 112 may be configured to dynamically adapt the QP and/or frame rate, or any other motion-related property of the encoding, in dependence on any one or more of the above factors. By dynamically adapt is meant “on the fly”, i.e. in response to ongoing conditions; so as the user 100 moves within the scene 113 or in and out of the scene 113, the current encoding state adapts accordingly. Thus the encoding of the video adapts according to what the user 100 being recorded is doing and/or where he or she is at the time of the video being captured.

In embodiments the controller 112 is a bitrate controller of the encoder 104 (note that the illustration of encoder 104 and controller 112 is only schematic and the controller 112 could equally be considered a part of the encoder 104). The bitrate controller 112 is responsible for controlling properties of the encoding which will affect the bitrate of the encoded video signal, in order to control the bitrate to remain at a certain level or within a certain limit—i.e. at or within a certain “bitrate budget”. The QP and the frame rate are examples of such properties: lower QP (finer quantization) incurs more bits per unit time of video, as does a higher frame rate; while higher QP (coarser quantization) incurs fewer bits per unit time of video, as does a lower frame rate. Typically the bitrate controller 112 is configured to dynamically determine a measure the available bandwidth over the channel between the transmitting terminal 102 and receiving terminal 108, and the bitrate budget is limited by this—either being set equal to the maximum available bandwidth or determined as some function of it. The bitrate controller 112 then adapts the properties of the encoding which affect bitrate in dependence on the current bitrate budget.

In embodiments disclosed herein, the controller 112 is configured to balance the trade-off between the QP and the frame rate so as to keep the bitrate of the encoded video signal at or within the current bitrate budget, and to dynamically adapt the manner in which this balance is struck based on the skeletal tracking information.

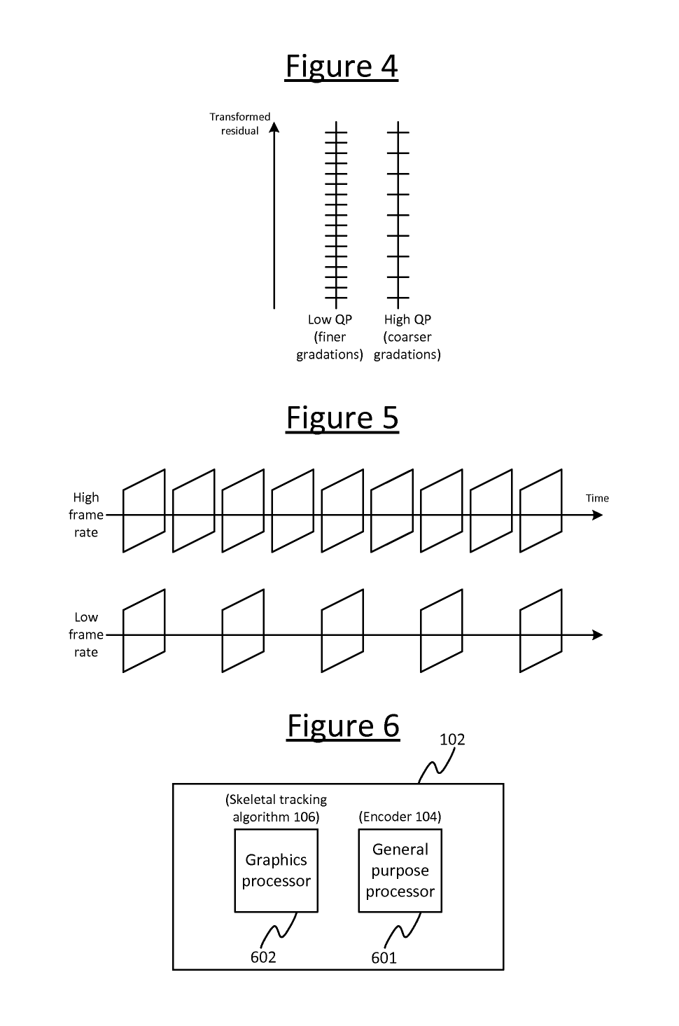

FIG. 4 illustrates the concept of quantization. The quantization parameter (QP) is an indication of the step size used in the quantization. A low QP means the quantized samples are represented on a scale with finer gradations, i.e. more closely-spaced steps in the possible values the samples can take (so less quantization compared to the input signal); while a high QP means the samples are represented on a scale with coarser gradations, i.e. more widely-spaced steps in the possible values the samples can take (so more quantization compared to the input signal). Low QP signals incur more bits than low QP signals, because a larger number of bits is needed to represent each value. Note, the step size is usually regular (evenly spaced) over the whole scale, but it doesn't necessarily have to be so in all possible embodiments. In the case of a non-uniform change in step size, an increase/decrease could for example mean an increase/decrease in an average (e.g. mean) of the step size, or an increase/decrease in the step size only in a certain region of the scale.

FIG. 5 illustrates different frame rates. At higher frame rate there are more individual momentary images of the scene 113 per unit time and therefore a higher bitrate, and at lower frame rate there are more individual momentary images of the scene 113 per unit time and therefore a lower bitrate.

Hence in trading-off quantization against frame rate to maintain a certain bit budget, if the controller 112 decreases the QP then it will also decrease the frame rate to accommodate, and if the controller increases the QP then it will also increase the frame rate to accommodate this. However, the QP and frame rate do not just affect bitrate: they also affect the perceived quality. Further, the effect of both the QP and the frame rate on perceived quality varies in dependence on motion, but their effects vary differently. In embodiments, the controller 112 is configured to dynamically adapt the trade-off between QP and frame-rate in dependence on the skeletal tracking information from the skeletal tracking algorithm 106.

When bandwidth is limited in a video conference, there is trade-off in frame quality vs. fluidity that can be optimized depending on the intention of user. There is a choice between spending the bits on increasing the quality of individual frames, e.g. reducing quantization parameter with potentially reduced frame-rate, vs. increasing frame-rate with potentially reduced frame quality. As recognized herein, the most appropriate trade-off may depend on the scenario. For instance, fluidity is more relevant for showing some sport activity than for showing someone sitting statically in front of the camera. Also, in real-world usage, the content may change from one scenario to another, and so it would be desirable if the encoder could adapt quickly to that.

According to the present disclosure, skeletal tracking can be used to find out what the user is doing in front of the camera, or whether the user is even present, so as to adapt the encoder tuning accordingly. For instance, three different scenarios may be defined:

(i) nobody is in the video, (ii) someone is in the video but sitting or standing still, and (iii) someone is in the video with active motion.

It may be assumed that the background is quite static, e.g. in the case where the transmitting user terminal 102 is a static terminal such as a “set-top” (non-handheld) games console.

In embodiments the controller 112 is configured to apply three different respective tuning parameter combinations to the encoder 104 for each of the three scenarios above: (i) reduce frame rate to 10 fps, and optimize for frame quality only; (ii) allow higher frame rate, but prioritize frame quality; and (iii) prioritize frame rate and ensure it is never below 15 fps.

In some embodiments, the scheme may also be optimized for the transition of the scenarios. When moving from scenario (i) to (ii) or (iii), there might be a rapid increase in frame complexity which may lead to a spike in encoded frame size. E.g. in scenario (i), QP may become very low and when someone comes in to the picture, encoding the frame with same QP will make the frame very large, potentially causing issues. For instance, delay may be introduced due to the fact that a large frame will take longer to transmit, and/or the spike of traffic due to a large frame may introduce network congestion and lead to packet loss. Skeletal tracking can be used to identify this change and take precautions to prevent that, e.g. by proactively increasing QP. That is, skeletal tracking may be able to reveal a large motion earlier compared to traditional motion detection algorithms that are based on block-motion. If a large motion is detected earlier, the controller 112 can reduce the frame quality to be “prepared” for the upcoming complexity. The controller 112 can also proactively generate a new key-frame (i.e. a new intra coded frame) when it detects that the scenario has changed, and this may help the future packet loss recovery.

Furthermore, in embodiments the use of skeletal tracking can be more efficient compared to other approaches such as estimating the amount of motion in the scene based on residuals and motion vectors. Trying to analyse what the user is doing in a scene can be very computationally expensive. However, some devices have reserved processing resources set aside for certain graphics functions such as skeletal tracking, e.g. dedicated hardware or reserved processor cycles. If these are used for the analysis of the user's motion based on skeletal tracking, then this can relieve the processing burden on the general-purpose processing resources being used to run the encoder, e.g. as part of the VoIP client or other such communication client application conducting the video call.

For instance, as illustrated in FIG. 6, the transmitting user terminal 102 may comprise a dedicated graphics processor (GPU) 602 and general purpose processor (e.g. a CPU) 601, with the graphics processor 602 being reserved for certain graphics processing operations including skeletal tracking. In embodiments, the skeletal tracking algorithm 106 may be arranged to run on the graphics processor 602, while the encoder 104 may be arranged to run on the general purpose processor 601 (e.g. as part of a VoIP client or other such video calling client running on the general purpose processor). Further, in embodiments, the user terminal 102 may comprise a “system space” and a separate “application space”, where these spaces are mapped onto separate GPU and CPU cores and different memory resources. In such cases, the skeleton tracking algorithm 106 may be arranged to run in the system space, while the communication application (e.g. VoIP client) comprising the encoder 104 runs in the application space. An example of such a user terminal is the Xbox One, though other possible devices may also use a similar arrangement.

FIG. 7 shows an example arrangement in which the skeletal tracking sensor 105 is used to detect skeletal tracking information. In this example, the skeletal tracking sensor 105 and the camera 103 which captures the outgoing video being encoded are both incorporated in the same external peripheral device 703 connected to the user terminal 102, with the user terminal 102 comprising the encoder 104, e.g. as part of a VoIP client application. For instance the user terminal 102 may take the form of a games console connected to a television set 702, through which the user 100 views the incoming video of the VoIP call. However, it will be appreciated that this example is not limiting.

In embodiments, the skeletal tracking sensor 105 is an active sensor which comprises a projector 704 for emitting non-visible (e.g. IR) radiation and a corresponding sensing element 706 for sensing the same type of non-visible radiation reflected back. The projector 704 is arranged to project the non-visible radiation forward of the sensing element 706, such that the non-visible radiation is detectable by the sensing element 706 when reflected back from objects (such as the user 100) in the scene 113.

The sensing element 706 comprises a 2D array of constituent 1D sensing elements so as to sense the non-visible radiation over two dimensions. Further, the projector 704 is configured to project the non-visible radiation in a predetermined radiation pattern. When reflected back from a 3D object such as the user 100, the distortion of this pattern allows the sensing element 706 to be used to sense the user 100 not only over the two dimensions in the plane of the sensor's array, but to also be used to sense a depth of various points on the user's body relative to the sensing element 706.

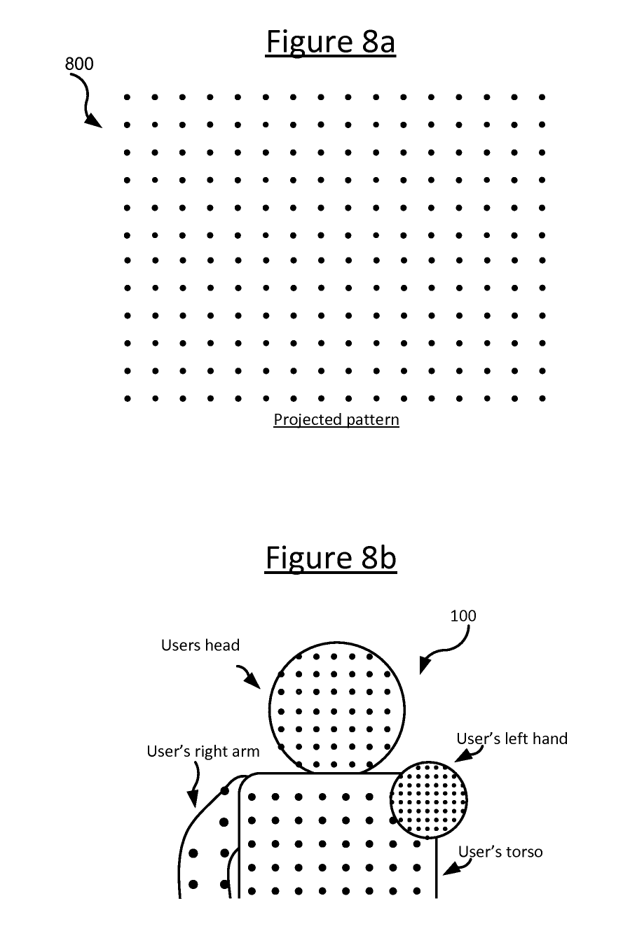

FIG. 8a shows an example radiation pattern 800 emitted by the projector 706. As shown in FIG. 8a, the radiation pattern extends in at least two dimensions and is systematically inhomogeneous, comprising a plurality of systematically disposed regions of alternating intensity. By way of example, the radiation pattern of FIG. 8a comprises a substantially uniform array of radiation dots. The radiation pattern is an infra-red (IR) radiation pattern in this embodiment, and is detectable by the sensing element 706. Note that the radiation pattern of FIG. 8a is exemplary and use of other alternative radiation patterns is also envisaged.

This radiation pattern 800 is projected forward of the sensor 706 by the projector 704. The sensor 706 captures images of the non-visible radiation pattern as projected in its field of view. These images are processed by the skeletal tracking algorithm 106 in order to calculate depths of the users' bodies in the field of view of the sensor 706, effectively building a three-dimensional representation of the user 100, and in embodiments thereby also allowing the recognition of different users and different respective skeletal points of those users.

FIG. 8b shows a front view of the user 100 as seen by the camera 103 and the sensing element 706 of the skeletal tracking sensor 105. As shown, the user 100 is posing with his or her left hand extended towards the skeletal tracking sensor 105. The user's head protrudes forward beyond his or her torso, and the torso is forward of the right arm. The radiation pattern 800 is projected onto the user by the projector 704. Of course, the user may pose in other ways.

As illustrated in FIG. 8b, the user 100 is thus posing with a form that acts to distort the projected radiation pattern 800 as detected by the sensing element 706 of the skeletal tracking sensor 105 with parts of the radiation pattern 800 projected onto parts of the user 100 further away from the projector 704 being effectively stretched (i.e. in this case, such that dots of the radiation pattern are more separated) relative to parts of the radiation projected onto parts of the user closer to the projector 704 (i.e. in this case, such that dots of the radiation pattern 800 are less separated), with the amount of stretch scaling with separation from the projector 704, and with parts of the radiation pattern 800 projected onto objects significantly backward of the user being effectively invisible to the sensing element 706. Because the radiation pattern 800 is systematically inhomogeneous, the distortions thereof by the user's form can be used to discern that form to identify skeletal features of the user 100, by the skeletal tracking algorithm 106 processing images of the distorted radiation pattern as captured by sensing element 706 of the skeletal tracking sensor 105. For instance, separation of an area of the user's body 100 from the sensing element 706 can be determined by measuring a separation of the dots of the detected radiation pattern 800 within that area of the user.

Note, whilst in FIGS. 8a and 8b the radiation pattern 800 is illustrated visibly, this is purely to aid in understanding and in fact in embodiments the radiation pattern 800 as projected onto the user 100 will not be visible to the human eye.

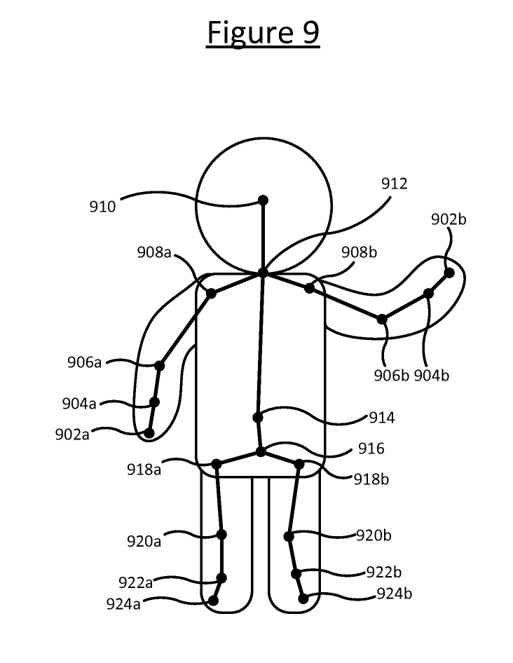

Referring to FIG. 9, the sensor data sensed from the sensing element 706 of the skeletal tracking sensor 105 is processed by the skeletal tracking algorithm 106 to detect one or more skeletal features of the user 100. The results are made available from the skeletal tracking algorithm 106 to the controller 112 of the encoder 104 by way of an application programming interface (API) for use by software developers.

The skeletal tracking algorithm 106 receives the sensor data from the sensing element 706 of the skeletal tracking sensor 105 and processes it to determine a number of users in the field of view of the skeletal tracking sensor 105 and to identify a respective set of skeletal points for each user using skeletal detection techniques which are known in the art. Each skeletal point represents an approximate location of the corresponding human joint relative to the video being separately captured by the camera 103.

In one example embodiment, the skeletal tracking algorithm 106 is able to detect up to twenty respective skeletal points for each user in the field of view of the skeletal tracking sensor 105 (depending on how much of the user's body appears in the field of view). Each skeletal point corresponds to one of twenty recognized human joints, with each varying in space and time as a user (or users) moves within the sensor's field of view. The location of these joints at any moment in time is calculated based on the user's three dimensional form as detected by the skeletal tracking sensor 105. These twenty skeletal points are illustrated in FIG. 9: left ankle 922b, right ankle 922a, left elbow 906b, right elbow 906a, left foot 924b, right foot 924a, left hand 902b, right hand 902a, head 910, centre between hips 916, left hip 918b, right hip 918a, left knee 920b, right knee 920a, centre between shoulders 912, left shoulder 908b, right shoulder 908a, mid spine 914, left wrist 904b, and right wrist 704a.

In some embodiments, a skeletal point may also have a tracking state: it can be explicitly tracked for a clearly visible joint, inferred when a joint is not clearly visible but skeletal tracking algorithm is inferring its location, and/or non-tracked. In further embodiments, detected skeletal points may be provided with a respective confidence value indicate a likelihood of the corresponding joint having been correctly detects. Points with confidence values below a certain threshold may be excluded from further use by the controller 112 to determine any ROIs.

The skeletal points and the video from camera 103 are correlated such that the location of a skeletal point as reported by the skeletal tracking algorithm 106 at a particular time corresponds to the location of the corresponding human joint within a frame (image) of the video at that time. The skeletal tracking algorithm 106 supplies these detected skeletal points as skeletal tracking information to the controller 112 for use thereby. For each frame of video data, the skeletal point data supplied by the skeletal tracking information comprises locations of skeletal points within that frame, e.g. expressed as Cartesian coordinates (x,y) of a coordinate system bounded with respect to a video frame size. The controller 112 receives the detected skeletal points for the user 100 and is configured to determine therefrom a plurality of visual bodily characteristics of that user, i.e. specific body parts or regions. Thus the body parts or bodily regions are detected by the controller 112 based on the skeletal tracking information, each being detected by way of extrapolation from one or more skeletal points provided by the skeletal tracking algorithm 106 and corresponding to a region within the corresponding video frame of video from camera 103 (that is, defined as a region within the afore-mentioned coordinate system).

It should be noted that these visual bodily characteristic are visual in the sense that they represent features of a user's body which can in reality be seen and discerned in the captured video; however, in embodiments, they are not detected in the video data captured by camera 103; rather the controller 112 extrapolates an (approximate) relative location, shape and size of these features within a frame of the video from the camera 103 based the arrangement of the skeletal points as provided by the skeletal tracking algorithm 106 and sensor 105 (and not based on e.g. image processing of that frame). For example, the controller 112 may do this by approximating each body part as a rectangle (or similar) having a location and size (and optionally orientation) calculated from detected arrangements of skeletal points germane to that body part.

It will be appreciated that the above embodiments have been described only by way of example.

For instance, the above has been described in terms of a certain encoder implementation comprising a transform 202, quantization 203, prediction coding 207, 201 and lossless encoding 204; but in alternative embodiments the teachings disclosed herein may also be applied to other encoders not necessarily including all of these stages. E.g. the technique of adapting QP and frame rate may be applied to an encoder without transform, prediction and/or lossless compression, and perhaps only comprising a quantizer.

Further, the scope of the present disclosure is not just limited to adapting quantization granularity and frame rate. For instance, both need not be adapted together or at the same time. Also the lower frame rate may not be the intention (as high frame rate is always preferred), but rather may be a consequence of finer granularity and limited bandwidth. Even more generally, other encoding properties are also perceived differently depending on motion in the video, and hence the scope of the disclosure may also extend to adapting other motion-related properties of the encoder (other than quantization granularity and frame rate) in dependence on skeletal tracking information. Note also that in embodiments where the quantization is adapted, QP is not the only possible parameter for expressing quantization granularity.

Note also that where it is said that a coarser or finer quantization granularity is applied, this does not necessarily have to be applied across the whole frame area (although in embodiments it may be). For example, if a coarser quantization is applied when a user is detected to be moving, the coarser granularity may not be applied in one or more regions of the frame corresponding to one or more selected body parts and/or other objects. E.g. it may be desirable to still keep the face at a higher quality, of if the person is kicking a ball then the legs and ball may be kept more clear. Such body parts or objects could be detected by the skeletal tracking algorithm, or by a separate image recognition algorithm or face recognition algorithm applied to the video from the camera 103 (the video being encoded), or a combination of such techniques.

Further, while the video capture and adaptation is dynamic, it is not necessarily the case in all possible embodiments that the video necessarily has to be encoded, transmitted and/or played out in real time (though that is certainly one application). E.g. alternatively, the user terminal 102 could record the video and also record the skeletal tracking in synchronization with the video, and then use that to perform the encoding at a later date, e.g. for storage on a memory device such as a peripheral memory key or dongle, or to attach to an email.

Further, where it is mentioned herein that the skeletal tracking is used to detect motion of the user 100 relative to the scene 113, this is not necessarily limited to detecting the absolute motion of the user while the scene stays still. In embodiments, the skeletal tracking algorithm 106 could also detect when the camera 103 moves (e.g. pans) relative to the scene 113.

Furthermore, note that in the description above the skeletal tracking algorithm 106 performs the skeletal tracking based on sensory input from one or more separate, dedicated skeletal tracking sensors 105, separate from the camera 103 (i.e. using the sensor data from the skeletal tracking sensor(s) 105 rather than the video data being encoded by the encoder 104 from the camera 103). Nonetheless, other embodiments are possible. For instance the skeletal tracking algorithm 106 may in fact be configured to operate based on the video data from the same camera 103 that is used to capture the video being encoded, but in this case the skeletal tracking algorithm 106 is still implemented using at least some dedicated or reserved graphics processing resources separate than the general-purpose processing resources on which the encoder 104 is implemented, e.g. the skeletal tracking algorithm 106 being implemented on a graphics processor 602 while the encoder 104 is implemented on a general purposes processor 601, or the skeletal tracking algorithm 106 being implemented in the systems space while the encoder 104 is implemented in the application space. Thus more generally than described in the description above, the skeletal tracking algorithm 106 may be arranged to use at least some separate hardware than the camera 103 and/or encoder 104—either a separate skeletal tracking sensor other than the camera 103 used to capture the video being encoded, and/or separate processing resources than the encoder 104.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device comprising:
an encoder for encoding a video signal representing a video image of a scene captured by a camera; and
a controller for receiving skeletal tracking information from a skeletal tracking algorithm relating to one or more skeletal features of a user when present in said scene, wherein the controller is configured to adapt a current value of one or more motion-related properties of the encoding in dependence on the skeletal tracking information as currently relating to said scene.

2. The device of claim 1, wherein the encoder comprises a quantizer for performing a quantization on said video signal as part of said encoding, and said one or more properties comprise a granularity of the quantization.

3. The device of claim 1, wherein said one or more properties comprise a frame rate of the encoding.

4. The device of claim 2, wherein said properties comprise both the quantization granularity and a frame rate of the encoding.

5. The device of claim 1, wherein the controller is configured to perform said adaptation of the one or more properties such that a bitrate of the encoding remains within a current bitrate budget.

6. The device of claim 5, wherein the controller is configured to perform said adaptation such that the bitrate of the encoding remains constant at the current bitrate budget.

7. The device of claim 1, wherein said adaptation comprises adapting the one or more properties in dependence on whether or not a user is currently detected to be present in said scene based on the skeletal tracking information.

8. The device of claim 1, wherein said adaptation comprises applying a finer granularity quantization and/or lower frame rate when no user is currently detected to be present in the scene based on the skeletal tracking information, and a coarser granularity quantization and/or higher frame rate when a user is currently detected to be present in said scene based on the skeletal tracking information.

9. The device of claim 1, wherein said adaptation comprises adapting the one or more properties in dependence on motion of the user relative to said scene, as currently detected based on the skeletal tracking information.

10. The device of claim 9, wherein said adaptation comprises adapting the one or more properties in dependence on whether or not a user is detected to be moving relative to said scene based on the skeletal tracking information.

11. The device of claim 1, wherein said adaptation comprises applying a finer granularity quantization and/or lower frame rate when no user is currently detected to be moving in the scene based on the skeletal tracking information, and a coarser granularity quantization and/or higher frame rate when a user is currently detected to be moving in the scene based on the skeletal tracking information.

12. The device of claim 9, wherein said adaptation comprises adapting said one or more properties in dependence on a degree of motion of the user currently detected based on the skeletal tracking information.

13. The device of claim 4, wherein said adaptation comprises:
(i) applying a finer granularity quantization and lower frame rate when no user is currently detected to be present in the scene based on the skeletal tracking information,
(ii) applying an intermediate granularity quantization and frame rate when a user is detected based on the skeletal tracking information to be present in the scene but not moving, and
(iii) applying a coarser granularity quantization and higher frame rate when a user is detected based on the skeletal tracking information to be both present in the scene and moving.

14. The device of claim 8, wherein the controller is configured to trigger inclusion of a new key frame in the encoding when switching between the different quantization granularities.

15. The device of claim 1, comprising a transmitter for transmitting the encoded video signal over a network.

16. The device of claim 1, wherein the skeletal tracking algorithm is implemented on said device and is configured to determine said skeletal tracking information based on one or more separate sensors other than said camera.

17. The device of claim 1, comprising dedicated graphics processing resources and general purpose processing resources, wherein the skeletal tracking algorithm is implemented in the dedicated graphics processing resources and the encoder is implemented in the general purpose processing resources.

18. The device of claim 17, wherein the general purpose processing resources comprise a general purpose processor and the dedicated graphics processing resources comprise a separate graphics processor, the encoder being implemented in the form of code arranged to run on the general purpose processor and the skeletal tracking algorithm being implemented in the form of code arranged to run on the graphics processor.

19. A computer program product comprising code embodied on a computer-readable storage medium and configured so as when run on one or more processors to perform operations of:
encoding a video signal representing a video image of a scene captured by a camera;
receiving skeletal tracking information from a skeletal tracking algorithm, the skeletal tracking information relating to one or more skeletal features of a user when present in said scene; and
adapting a current value of one or more motion-related properties of the encoding in dependence on the skeletal tracking information as currently relating to said scene.

20. A method comprising:
encoding a video signal representing a video image of a scene captured by a camera;
receiving skeletal tracking information from a skeletal tracking algorithm, the skeletal tracking information relating to one or more skeletal features of a user when present in said scene; and
adapting a current value of one or more motion-related properties of the encoding in dependence on the skeletal tracking information as currently relating to said scene.
